(19) United States
(12) Patent Application Publication
(10) Pub. No.: US 2013/0327125 A1
(43) Pub. Date: Dec. 12, 2013

(54) METHOD FOR GEOCHEMICAL GRANDIENT EXPLORATION

(71) Applicants: Zhanxiang He, Zhuozhou (CN); Xiaodong Suo, Zhuozhou (CN); Weibin Sun, Zhuozhou (CN)

(72) Inventors: Zhanxiang He, Zhuozhou (CN); Xiaodong Suo, Zhuozhou (CN); Weibin Sun, Zhuozhou (CN)

(21) Appl. No.: 13/976,887

(22) PCT Filed: Mar. 11, 2011
(86) PCT No.: PCT/CN11/00390

§ 371 Date: Aug. 23, 2013

(30) Foreign Application Priority Data
Dec. 29, 2010 (CN) 201010611852.6

(51) Int. Cl. G01N 1/22

(52) U.S. Cl. CPC G01N 1/2294
USPC 73/31.05

(57) ABSTRACT

A method for geochemical gradient exploration includes the steps of: densely collecting soil samples and gas samples along a longitudinal direction in a certain depth range of a superficial layer; collecting soil samples and gas samples in the range from 1 meter to 50 meters deep by a special drilling machine; after analyzing and processing the geochemical indicators, extracting and figuring the bathymetric curve and the curve of gradients, the section curve and section curve of gradient along a certain direction, contour section of various indicators and contour section of various indicator gradients, so as to process the data and to represent the figure in 3D. More information, especially the variation information along the longitudinal direction, can be obtained. Gradient prospecting is realized by collecting samples along the depth direction and by analyzing variations in geochemical indicators along the depth.

### CROSS-REFERENCE TO RELATED APPLICATION

The present application is an application filed under 35 U.S.C.§371, claiming priority to PCT/CN2011/000390, filed Mar. 11, 2011, which claims priority to CN 201010611852.6, filed on Dec. 29, 2010. The contents of these applications are incorporated herein by reference in their entirety.

### FIELD

The present invention relates to a method for acquiring and processing data in geochemical exploration.

### BACKGROUND

Nowadays, geochemistry has been widely utilized in the exploration for metal minerals and oil/gas resources as well as in the environmental monitoring. However, the collection of geochemical samples still follows the traditional way, wherein a sample is collected at a certain depth for each station. Several basic means for collection of soil samples include: sampling by digging, sampling with a percussion drill and shallow well sampling. Meanwhile, the gas samples are usually collected with a vacuum syringe by drilling to a desired depth. Mineral anomalies are then observed by analyzing these soil or gas samples. The above sampling method can only obtain the information of lateral variation for the geochemical anomaly at a certain depth, and thus is generally difficult to satisfy the exploration requirements such as layer-by-layer sampling and isobathic sampling. As a result, it is difficult to study the variation pattern of the geochemical indicators in the same layer or under isobathic condition. The anomaly variations relative to the depth cannot be realized. In particular, the anomaly characteristics caused by modern anthropogenic pollution is significantly different from anomaly characteristics caused by underground metal minerals or reservoirs. As the depth increases, the former is usually weakened, whereas the latter is enhanced. One type of data can hardly identify the type of anomalies, thereby leading to wrong conclusions in the actual exploration practice. The typical method does not result in satisfactory results. The above-mentioned problems affect further development of the typical sampling method because the typical method itself cannot solve these problems.

### SUMMARY

The objects of the present invention is to provide a method for geochemical gradient exploration by which the variation pattern in the same layer or under isobathic condition can be obtained.

In order to achieve the above object, the present invention is carried out by the following technical solution:

(1) At each station, a set of samples are obtained by alternately collecting soil samples and gas samples at an interval of 0.5-1 meter underneath the earth surface. Said alternately collecting in step 1) may be carried out by collecting soil and gas samples from shallow layers to deep layers, wherein the depth is in the range of 20-50 meters.

(2) The obtained soil and gas samples are analyzed for their respective geochemical indicators. Said analysis for the geochemical indicators may comprise detecting the composition and content of hydrocarbons in the soil and gas samples. Said hydrocarbons may comprise methane, and said content may be the content of methane.

(3) Curves of the geochemical indicator(s) verse depth and curves of the geochemical indicator(s) gradient verse depth are created based on the analysis of the geochemical indicator(s) for each station. Then the profile curves of the geochemical indicator(s) and the profile curves of the geochemical indicator(s) gradient for each depth are created, wherein the profile is along the survey line;

(4) Contours (isoline maps) of the geochemical indicator(s) and contours (isoline maps) of the geochemical indicator gradient for the profile are created based on the curves obtained in step (3);

(5) A three-dimensional (3D) visible diagram of areal acquisition is created based on the contours obtained in step (3).

(6) The area enriched with metal minerals or reservoirs is determined based on the variation characteristics of the geochemical indicators relative to the change in depth and the anomalies of the geochemical indicators gradient in the 3D visible diagram. Said area enriched with metal minerals or reservoirs in step 6) is an anomalous zone with values of the geochemical indicator increasing with depth in 3D visible map, which is the oil-bearing zone or the zone enriched with metal minerals.

### DRAWINGS

FIG. 1 is a schematic diagram of a method for geochemical gradient sampling;

FIG. 2 is a curve of methane indicator versus survey depth for a station according to the present invention;

FIG. 3 is a diagram showing the profile curve of methane indicator versus survey depth along a survey line according to the present invention;

FIG. 4 is a diagram showing the isobathic profile curve of methane indicator along a survey line according to the present invention; and

FIG. 5 is a section diagram showing contours of a methane indicator along a survey line according to the present invention.

### DETAILED DESCRIPTION OF THE INVENTION

The present invention will be described in detail below with reference to the drawings.

The present invention can be implemented by the following steps:

### (1) Collecting Geochemical Samples

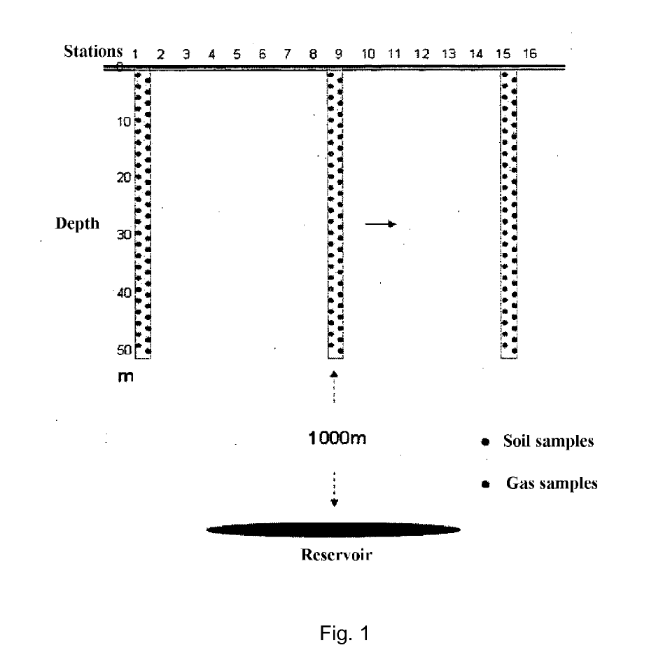

Station locations for collecting the geochemical samples are determined based on the coordinates from on-site survey. At Station 1, for instance, soil and gas samples are collected with a specialized driller underneath an earth surface up to a depth of 50 meters. A set of samples are obtained by collecting soil and gas samples at an interval of 1 meter. In other words, the first soil sample is collected when reaching 1-meter depth and stored in a sample bag, and the first gas sample is collected when reaching 2-meter depth, sealed in a glass tube and labeled as q1, followed by sending them to a sample analyzing vehicle. Subsequently, the second soil sample is collected when reaching 3-meter depth, whereas the second gas sample is collected when reaching 4-meter depth. Up to 50-meter depth, 25 soil samples (t1, t2 . . . t25) and 25 gas samples (g1, g2 . . . g25) are collected from such station. The driller is then transported to the second station and continues to collect the samples at the second station. The above operations are repeated so as to obtain the soil and gas samples at the second station. The same procedure is further repeated until the sampling for all the stations have been finished. The results are shown in FIG. 1.

### (2) Analyzing Geochemical Indicators

The geochemical indicators of the samples are analyzed by a method similar to conventional geochemical methods, wherein the gas samples are analyzed in-situ, whereas the soil samples are sent to a base station for analysis.

The content of various geochemical indicators, such as methane, ethane and propane etc., can be obtained by analyzing the composition and content of hydrocarbons in the soil and gas samples. For example, the depth indicators of methane for the soil samples from Station 1 are F^{t1}, F^{t2}, F^{t3} . . . F^{t25}, and the depth indicators of methane for the gas samples at Station 1 are F^{q1}, F^{q2}, F^{q3} . . . F^{q25}. Similarly, a series of data are obtained from the other stations.

### (3) Processing Data Into Drawings

### (a) Curves Versus Survey Depth And Curves of Gradient Versus Survey Depth

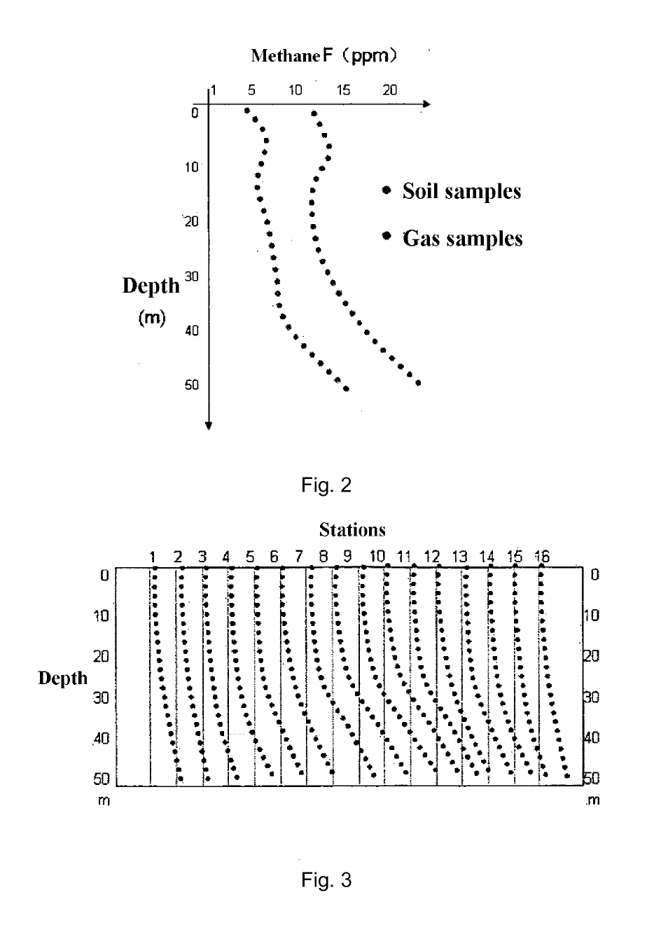

Curves of geochemical indicators versus depth are created based on the analysis of the geochemical indicators for each station, wherein the depth is the vertical axes with “meter” as the unit and geochemical indicators are horizontal axes with “ppm” as the unit. The curves of methane versus depth is created and shown in FIG. 2. Meanwhile, the curves of methane gradient can be created, which is the curve of a change rate of methane versus depth.

### (b) Profile Curves

The profile curves of methane indicator are formed by forming a profile along the survey line with the methane indicator from all the stations. The horizontal axis is the stations and the vertical axis is the methane indicator. The profile curves of methane are shown in FIG. 3.

### (c) Profile Curves And the Profile Curve of Gradient Versus Depth

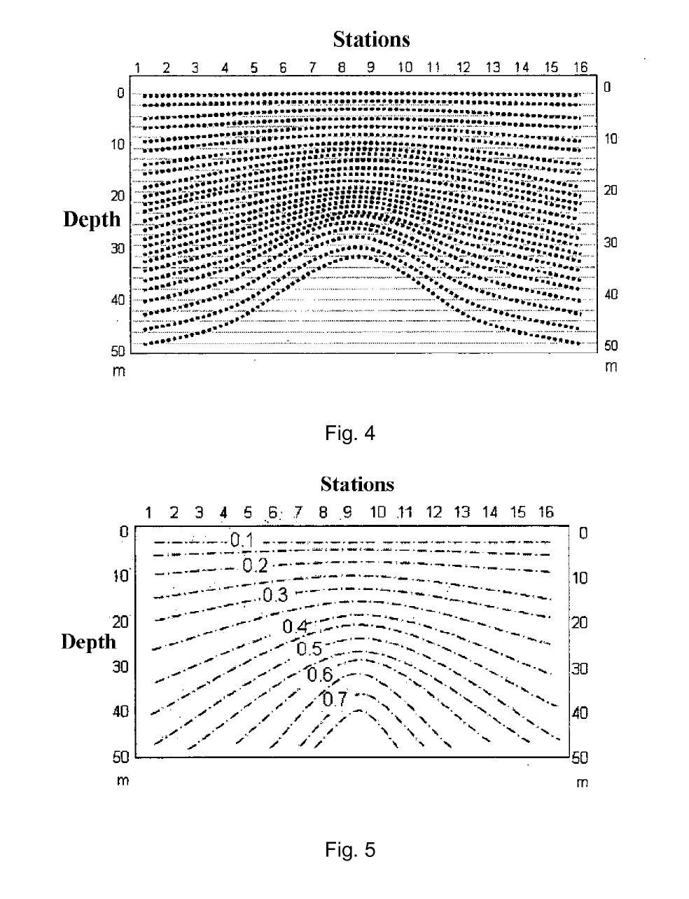

The profile curves of geochemical indicators versus survey depth are created by combining the curves of methane versus survey depth from all stations into a profile. The horizontal axis is the stations and the vertical axis is the depth. The profile curves of methane versus survey depth are shown in FIG. 4. Meanwhile, the profile curves of methane gradient versus survey depth can be created by combining the curves of methane gradient along the depth into a profile.

### (d) Section Diagrams of Contours (Isolines) And Contours (Isolines) of Gradient

The diagram of contours (isolines) of methane indicator is created based on the methane indicators of every survey line, wherein the horizontal axis is the stations and the vertical axis is the depth. The diagram of contours of methane indicator versus survey depth for one of the survey lines is shown in FIG. 4. Meanwhile, the diagram of contours of methane gradient versus survey depth can also be created.

### (e) The 3D Visible Diagram

As for the areal acquisition, the 3D visible diagram of methane is created in light of 3D coordinates, that is, the planimetric coordinates are the directions of south and north, and the vertical axis is the survey depth. Meanwhile, the 3D diagram of the methane indicator gradient can also be created.

(4) Identifying the area enriched with reservoirs or metal minerals based on the variation characteristics of the geochemical indicator versus depth and the anomalies of the geochemical indicators gradient as illustrated in the above-mentioned diagrams comprising the methane curves versus depth, the profile curves, the profile curves versus survey depth, section diagram of contours, the 3D visible diagram and diagrams of the corresponding gradient. An anomalous zone where the methane indicator, among others, anomalously increases with the depth is the oil-bearing zone or the zone enriched with metal minerals.

### INDUSTRIAL UTILITY

The present invention not only avoids the false anomaly caused by the interference of earth surface conditions, but also makes it possible to discover variation characteristics of the geochemical indicator relative to changes in depth, in particular the influence of the lithological variation of the strata to the geochemical indicator(s), and consequently to improve the accuracy for identifying deep reservoirs by geochemical exploration.

What is claimed is:

1. A method of exploring a natural resource, comprising:
obtaining a set of samples by alternately collecting soil samples and gas samples from underneath the earth surface, at a plurality of stations;
analyzing the soil and gas samples for their respective geochemical indicators;
creating curves of the geochemical indicators versus depth and curves of geochemical indicator gradients versus depth based on analysis of the geochemical indicators for each station;
creating profile curves of the geochemical indicators and the profile curves of the geochemical indicator gradients for each depth, wherein the profile is along the survey line;
forming a contours of the geochemical indicators thereof a contour of the geochemical indicator gradients for the profile based on the curves of the geochemical indicators and the curve of the geochemical indicator gradients;
creating a 3D visible diagram of areal acquisition based on the contours of the geochemical indicators and the contours of the geochemical indicator gradients;
determining an area enriched with the natural resource based on variation characteristics of the geochemical indicators relative to changes in depth and anomaly characteristics of the geochemical gradient in the 3D visible diagram.

2. The gradient method according to claim 1, wherein the obtaining of the set of samples by alternately collecting is carried out by collecting the soil and gas samples from shallow layers to deep layers, wherein the depth is in the range of 20-50 meters.

3. The method according to claim 1, wherein the analyzing of the obtained soil samples for their geochemical indicators is carried out by determining the composition and content of hydrocarbon in the soil samples.

4. The method according to claim 3, wherein said hydrocarbon is methane, and said content is the content of methane.

5. The method according to claim 1, wherein the area enriched with the natural resource is an anomalous zone where the geochemical indicator increases with depth in the 3D visible map.

6. A method of exploring a natural resource, comprising:
obtaining a set of samples at a plurality of depths underneath an earth surface;
determining at least one geochemical indicator in the set of samples; and
determining a reservoir of the natural resource based on variation characteristics of the at least one geochemical indicator relative to a change in depth underneath the earth surface.

7. The method according to claim 6, further comprising generating a curve of the at least one geochemical indicator versus depth and a curve of gradient of the at least one geochemical indictor versus depth.

8. The method according to claim 6, further comprising obtaining a set of samples from a plurality of stations located along the earth surface.

9. The method according to claim 8, further comprising generating a curve of the at least one geochemical indicator versus depth and a curve of gradient of the at least one geochemical indictor versus depth for each station.

10. The method according to claim 9, further comprising generating a profile curve of the at least one geochemical indicator and the profile curve of the gradient of the at least one geochemical indicator for each depth.

11. The method according to claim 10, further comprising generating a contour of the at least one geochemical indicator and a contour of the gradient of the at least one geochemical indicator based on the curve of the at least one geochemical indicator and the curve of the gradient of the at least one geochemical indicator.

12. The method according to claim 11, further comprising generating a 3D visible diagram of areal acquisition based on the contour of the at least one geochemical indicator and the contour of the gradient of the at least one geochemical indicator.

13. The method according to claim 6, further comprising identifying an anomalous zone based on the variation characteristics of the at least one geochemical indicator relative to changes in depth.

14. The method according to claim 13, wherein the anomalous zone is the reservoir of the natural resource.

15. The method according to claim 6, wherein the plurality of depths are arranged at a predetermined interval.

16. The method according to claim 15, wherein the interval is in a range of 0.5-1 meter.

17. The method according to claim 6, wherein the plurality of depths are in the range of 20 to 50 meters underneath the earth surface.

18. The method according to claim 6, wherein the identifying of the reservoir of the at least one natural resource is achieved based on the curve of the gradient of the geochemical indicator versus depth.

19. A method of exploring a natural resource, comprising:
obtaining a set of samples at a plurality of depths underneath an earth surface at a plurality stations disposed along the earth surface; and
determining a reservoir of the natural resource based on geochemical gradient based on the plurality of samples at the plurality depths at the plurality of stations.

20. The method according to claim 19, wherein the plurality of depths are arranged at an interval of 0.5 to 1 meter up to a depth of 50 meters underneath the earth surface.
